(19) United States
(12) Patent Application Publication
(10) Pub. No.: US 2026/0188013 A1
(43) Pub. Date: Jul. 2, 2026

(54) COMPUTER-VISION-BASED SAFETY MONITORING AND EARLY WARNING METHOD AND SYSTEM FOR TRANSMISSION LINE

(71) Applicants: State Grid Taizhou Power Supply Company Of State Grid Jiangsu Electric Power Co., Ltd., Jiangsu (CN); State Grid Jiangsu Electric Power Co., Ltd., Jiangsu (CN); Jiangsu Frontier Electric Technology CO., LTD., Jiangsu (CN)

(72) Inventors: Xiao LU, Jiangsu (CN); Qiang WU, Jiangsu (CN); Chengling JIANG, Jiangsu (CN); Zhoujun MA, Jiangsu (CN); Maofei WANG, Jiangsu (CN); Qiwei WU, Jiangsu (CN); Yongdong DAI, Jiangsu (CN); Hua SHAN, Jiangsu (CN); Yiming TANG, Jiangsu (CN); Yuquan CHEN, Jiangsu (CN); Xin ZHANG, Jiangsu (CN); Chunlei XU, Jiangsu (CN); Chao GAO, Jiangsu (CN); Feng MAO, Jiangsu (CN); Rui FU, Jiangsu (CN); Ling JU, Jiangsu (CN); Wei FENG, Jiangsu (CN)

(73) Assignees: State Grid Taizhou Power Supply Company Of State Grid Jiangsu Electric Power Co., Ltd., Jiangsu (CN); State Grid Jiangsu Electric Power Co., Ltd., Jiangsu (CN); Jiangsu Frontier Electric Technology CO., LTD., Jiangsu (CN)

(21) Appl. No.: 18/863,336

(22) PCT Filed: Aug. 9, 2024
(86) PCT No.: PCT/CN2024/110920

§ 371 Date: Nov. 6, 2024

(30) Foreign Application Priority Data
Sep. 26, 2023 (CN) 202311252643.0

(51) Int. Cl. G06V 20/52; G06V 10/26; G06V 10/34; G06V 10/44; G06V 10/764; G06V 20/10

(52) U.S. Cl. CPC G06V 20/52; G06V 10/26; G06V 10/34; G06V 10/457; G06V 10/764; G06V 20/176

(57) ABSTRACT

A computer-vision-based safety monitoring and early warning method and system for a transmission line. The method includes: acquiring a scene image of the transmission line; identifying a transmission channel area and dynamic targets on the scene image; determining an interference result between the dynamic targets and the transmission channel area based on an identification result of the transmission channel area and the dynamic targets, specifically including: overlapping and comparing trajectory information of the dynamic targets with the transmission channel area to give an overlapping result; based on the overlapping result, screening out a dynamic target of which the trajectory information overlaps with the transmission channel area; and determining alarm information based on the interference result. The method and system automatically define a transmission channel area in the vicinity of a transmission tower, greatly reducing the workload of line monitoring personnel in artificially defining transmission channels.

### TECHNICAL FIELD

The present invention relates to the field of computer vision tracking technology, and more particularly to a computer-vision-based safety monitoring and early warning method and system for a transmission line.

### BACKGROUND

With accelerated urbanization, many construction activities have been carried out near transmission lines. The operation of large construction equipment, such as tower cranes, cement pouring trucks, excavators, and dump trucks, threatens the safe operation of power facilities. Therefore, there is an urgent need in the power industry for tools that can identify and respond to dynamic anomaly targets online. The dynamic anomaly targets are highly maneuverable and their trajectories are difficult to predict, which can cause unexpected damage to transmission lines and towers. Therefore, anomaly detection and identification needs to be fast and accurate so that timely action can be taken when necessary.

At present, the transmission channel anomaly detection usually focuses on detection of static targets, and is divided into manual inspection and camera inspection according to the detection method. The manual inspection is usually performed by professionals riding in power operation and maintenance vehicles or helicopters to maneuver along transmission lines and conduct visual monitoring to determine based on personal experience whether there are plants in the transmission channel or whether the area covered by buildings has invaded the transmission channel. The camera inspection is divided into fixed camera inspection and mobile camera inspection. Fixed camera inspection means that a surveillance camera installed on a specific tower shoots a scene for a corresponding transmission channel at certain time intervals, and transmits the shot pictures back to a data storage center, where the pictures are analyzed by line operation and maintenance personnel to determine the safety status of the channel. The mobile camera inspection generally mean that an unmanned aerial vehicle equipped with a surveillance camera cruises along a transmission line and transmits a cruising video back to an operator, who then determines the safety status of the line. For example, CN106932688A discloses a transmission line detector and a UAV-based transmission line detection system. The transmission line detector includes: a casing; a camera disposed on an outer wall of the casing; and an image pre-processor, a straight line detector, and a transmission line recognizer that are disposed in the casing. The camera is used to acquire image information of a target area; the image pre-processor is used to process the image information; the straight line detector is used to mark detected straight lines on the processed image information; the transmission line recognizer is used to mark recognized transmission lines on the image information marked with the straight lines, and output the image information marked with the transmission lines. The transmission line detector further includes a communication module for wirelessly transmitting the received image information marked with the transmission lines to an associated terminal. This system can detect the transmission lines more accurately from a complex background environment, bringing convenience to the relevant power staff, and improving the effectiveness and reliability of power inspection. However, neither the manual inspection nor the camera inspection can conduct real-time and uninterrupted online monitoring and safety discrimination of transmission channels, which makes the existing technology unable to be applied to the monitoring and early warning of dynamic targets on site.

The main challenges of dynamic anomaly detection are as follows. Autonomous monitoring of large-scale grid transmission channels requires algorithms that can adapt to the diversity of transmission scenarios and the complexity of on-site weather, and can automatically define transmission channels. It also requires algorithms that can support tracking of dynamic targets and discrimination of their dynamic trajectories and operation status to avoid misjudgment and omission of judgment.

Therefore, how to provide a transmission line monitoring method which is applicable to dynamic target tracking in different transmission scenarios and has high identification and early warning accuracy is an urgent problem to be solved in this field.

### SUMMARY

In view of the shortcomings in the prior art, the present invention provides a computer-vision-based safety monitoring and early warning method and system for a transmission line, which can improve the accuracy of safety early warning for the transmission line.

In a first aspect, the present invention provides a computer-vision-based safety monitoring and early warning method for a transmission line, which includes:
acquiring a scene image of a transmission line;
identifying a transmission channel area and dynamic targets on the scene image;
determining an interference result between the dynamic targets and the transmission channel area based on an identification result of the transmission channel area and the dynamic targets; and
determining alarm information based on the interference result.

Further, the step of identifying the transmission channel area on the scene image includes:
performing edge processing on the scene image to obtain edge information of straight line segments;
screening the edge information of straight line segments to give the transmission line; and
performing ground mapping on the given transmission line to form the transmission channel area.

Further, the step of performing edge processing on the scene image to obtain edge information of straight line segments includes:
converting the scene image into a grayscale image and performing edge detection to obtain edge information;
based on a grayscale threshold, classifying the edge information to obtain classified edge information;
performing binary grayscale conversion on the classified edge information to obtain a binary grayscale image;
performing Hough transform processing on the binary grayscale image to give polar coordinates of the edge information;
screening the polar coordinates of the edge information to give multiple sets of edge information that satisfy predetermined conditions; and
taking the edge information of the same set as edge information of one straight line segment;
where the predetermined conditions are that the number of pieces of the edge information in the same set is not less than a predetermined number, and the polar coordinates of all the edge information in the same set form a straight line segment in a polar coordinate system.

Further, the step of performing Hough transform processing on the binary grayscale image to give the polar coordinates of the edge information includes:

$$y = ax + b \to r = x cos θ + y sin θ$$

where (x, y) are the coordinates of the straight line segment in the binary grayscale image in a right-angle coordinate system, a is the slope of the straight line segment, b is the intercept of the straight line segment, (r, θ) are the polar coordinates of the straight line segment in the polar coordinate system after Hough transform processing, r is the distance from the origin to the straight line segment, and θ is an angle between r and the horizontal axis in the right-angle coordinate system.

According to the present invention, the straight line segments in the binary grayscale image can be screened out by performing Hough transform for the binary grayscale image to form polar coordinates, and the screened-out straight line segments are spliced in the right-angled coordinate system.

Further, the step of screening the edge information of the straight line segments to give the transmission line includes:
classifying straight line segments with the same slope in all the straight line segments into the same category;
joining the ends of two straight line segments with overlapping points in each category to form a straight line segment;
based on each category of straight line segments after joining, obtaining the lengths of all the straight line segments;
comparing the lengths of the straight line segments in each category with a length threshold to give a straight line segment of which the length is greater than the length threshold;
taking the straight line segment of which the length is greater than the length threshold in the same category as a transmission wire in the same location region; and
integrating the transmission wires in all the location regions to give the transmission line.

Further, the step of classifying straight line segments with the same slope in all the straight line segments into the same category includes:
making subtraction between the slopes of all the straight line segments in pairs to give slope difference results;
based on the slope difference threshold, screening all the slope difference results to give slope difference results that fall within the slope difference threshold, which is specifically as follows:

$$\vert {k}_{1} - {k}_{2} \vert < α$$

(3) Excellent scenario adaptability
where k1 and k2 are the slopes of two straight line segments and α is the slope difference threshold, α being 0.2; and
based on the screened slope difference results, classifying two straight lines corresponding to each slope difference result into the same category.

Further, the step of joining the ends of two straight line segments with overlapping points in each category to form a straight line segment includes:
acquiring the coordinates of the endpoints of all straight line segments in each category;
solving for an endpoint distance based on the coordinates of the endpoints of any two straight line segments in each category;
based on a distance threshold, screening all the solved endpoint distances to give endpoint distances that fall within the distance threshold, which is specifically as follows:

$$\sqrt{{( {x}_{1} - {x}_{2} )}^{2} + {( {y}_{1} - {y}_{2} )}^{2}} < β$$

where x1 and y1 are respectively the endpoint coordinates of one of the straight line segments, x2 and y2 are the endpoint coordinates of the other of the straight line segments, and β is the distance threshold, β being 20 pixels; and
classifying the two straight line segments corresponding to all given endpoint distances into two straight line segments with overlapping points and connecting the two corresponding endpoints.

Further, the step of performing ground mapping on the given transmission line to form a transmission channel area includes:
based on the Hough transform, identifying the given transmission line to obtain endpoints of two transmission wires located on the outer side in each location region;
connecting endpoints of the two transmission wires located on the outer side in all the location regions to obtain an outer envelope sub-region corresponding to the location region;
integrating all the outer envelope sub-regions to form an outer envelope region of the transmission line;
based on the coordinates of the connected endpoints, obtaining the boundary coordinates of the outer envelope region; and
symmetrically mapping the boundary coordinates of the outer envelope region along the horizontal axis of the scene image to form the transmission channel area.

Further, after obtaining the endpoints of the two transmission wires located on the outer side in each location region, the method further includes:
acquiring the coordinates of the endpoints of the two transmission wires located on the outer side in all location regions;
for the two transmission wires located on the outer side in each location region, determining the upper and lower endpoints of each transmission wire;
performing coordinate difference processing respectively on the longitudinal coordinates of the two lower endpoints and the longitudinal coordinates of the two upper endpoints in each location region;
comparing all coordinate difference processing results with an endpoint difference threshold to give a coordinate difference processing result that exceeds the endpoint difference threshold;
based on the given coordinate difference processing result, obtaining endpoints of two matching corresponding transmission wires; and
based on the endpoints of the two matching corresponding transmission wires, calculating the lengths of the two transmission wires corresponding to the endpoints; and for the transmission wire with a smaller length, adding a line segment having a slope same as the transmission wire and having a certain length along its matching corresponding endpoint; where the length of the added line segment is equal to a length difference between the two transmission wires.

Further, a coordinate difference processing result is the absolute value of the difference between the longitudinal coordinates of the two endpoints, and the endpoint difference threshold is 200 pixels.

Further, the step of identifying the dynamic targets on the scene image includes:
based on a pre-built target detection model, performing target detection on the scene image to give detection boxes, target types and location information of all targets in the scene image;
acquiring a target detection result of a scene image collected last time relative to the current scene image;
giving current trajectory information of the dynamic target by combining the target detection results of the current scene image and the scene image collected last time; and
acquiring historical trajectory information of the dynamic target and combined with the current trajectory information of the dynamic target, obtaining the trajectory information of the dynamic target.

Further, the step of giving current trajectory information of the dynamic target by combining the target detection results of the current scene image and the scene image collected last time includes:
overlapping and comparing all detection boxes in the current scene image with all detection boxes in the scene image collected last time to give an overlap and comparison result;
based on the overlap and comparison result, taking each detection box in the current scene image and a detection box with an overlapping portion in the scene image collected last time as a group of detection boxes;
screening each detection box group based on an overlap threshold, and removing, from the scene image collected last time, a detection box, of which the overlap and comparison result is less than the overlap threshold as compared with the detection box of the current scene image;
comparing the geometric centers of the detection boxes in the scene image collected last time that are left in each detection box group with the geometric center of the detection box in the current scene image to give a detection box in the scene image collected last time, of which the geometric center is nearest to that of the detection box in the current scene image; and
connecting the geometric center of the detection box in the current scene image in each detection box group to the geometric center of the given detection box in the scene image collected last time, to obtain trajectory information of a target corresponding to the detection box in the current scene image.

Further, the step of overlapping and comparing all detection boxes in the current scene image with all detection boxes in the scene image collected last time to give an overlap and comparison result is specifically:

$$IOU ( {box}_{1} , {box}_{2} ) = \frac{Area ( {box}_{1} ) ⋂ Area ( {box}_{2} )}{Area ( {box}_{1} ) ⋃ Area ( {box}_{2} )}$$

where IOU(box_1,box_2) is the overlap and comparison result, Area(box_1) is the detection box in the scene image collected last time, and Area(box_2) is the detection box in the current scene image.

Further, before the connection of the geometric center of the detection box in the current scene image in each detection box group to the geometric center of the given detection box in the scene image collected last time, the method further includes:
acquiring, from the current scene image, a detection box, of which the overlap and comparison result is that there is no overlap;
calculating the distances from the geometric center of the detection box having no overlap to the geometric centers of all detection boxes in the scene image collected last time, to give a detection box in the scene image collected last time, that has the smallest distance to the detection box having no overlap; and
classifying the detection box having no overlap and the given detection box having the smallest distance into a group.

Further, the step of giving the current trajectory information of the dynamic target by combining the target detection results of the current scene image and the scene image collected last time further includes:
according to the trajectory information of all targets in the current scene image, giving the overlap and comparison results corresponding to the trajectory information of all targets within a preset alarm time, and calculating a distance from the geometric center of the detection box in the current scene image to the geometric center of the corresponding detection box in the scene image collected last time within the preset alarm time; and
based on a dynamic overlap threshold and a dynamic distance threshold, screening the overlap and comparison results corresponding to the trajectory information of all the targets and the distances between the geometric centers, to give the trajectory information of the dynamic object, which includes:
removing the trajectory information of targets for which the overlap and comparison result is greater than the dynamic overlap threshold and the distance between the geometric centers is less than the dynamic distance threshold within the preset alarm time, and taking trajectory information of the remaining targets as the trajectory information of the dynamic targets.

Further, the step of screening the overlap and comparison results corresponding to trajectory information of all targets and the distances between the geometric centers based on the dynamic overlap threshold and the dynamic distance threshold meets the following relationships:

$$\{ \begin{matrix}IOU ( {box}_{n - 1}^{a} , {box}_{n}^{a} ) > μ , ∀ n ∈ [ 1 , N ] \\ \sqrt{{( {x}_{n - 1}^{a} - {x}_{n}^{a} )}^{2} + {( {y}_{n - 1}^{a} - {y}_{n}^{a} )}^{2}} < τ , ∀ n ∈ [ 1 , N ]\end{matrix}$$

where a is a time period between the moment corresponding to the current scene image and its previous moment at an interval of a preset alarm time, N is the number of frames in the scene image within the preset alarm time,

$${box}_{n}^{a}$$

is a detection box in the nth frame of scene image in the time period a,

$${x}_{n}^{a}$$

is the horizontal coordinates of the geometric center of the detection box in the nth frame of scene image in the time period a,

$${y}_{n}^{a}$$

is the vertical coordinates of the geometric center of the detection box in the nth frame of scene image in the time period a, u is the dynamic overlap threshold, and t is the dynamic distance threshold.

Further, the dynamic overlap threshold is 95% and the dynamic distance threshold is 10 pixels.

Further, the step of determining an interference result between the dynamic targets and the transmission channel area based on the identification result of the transmission channel area and the dynamic targets includes:
overlapping and comparing trajectory information of the dynamic targets with the transmission channel area to give an overlap result; and
based on the overlap result, screening out a dynamic target of which the trajectory information overlaps with the transmission channel area.

Further, the step of determining alarm information based on the interference result includes:
based on the position information of all targets in the current scene image and the transmission channel area, and combined with the dynamic targets whose trajectory information overlaps with the transmission channel area, giving a dynamic target located in the transmission channel area;
based on historical alarm information in a predetermined period of time, giving a historical dynamic target that has been alarmed;
matching the dynamic target located in the transmission channel area with the historical dynamic target that that has been alarmed, to give a dynamic target that has not been successfully matched; and
generating alarm information based on the dynamic target that has not been successfully matched.

Further, the step of generating alarm information based on the dynamic target that has not been successfully matched includes:
according to the trajectory information of the unsuccessfully matched dynamic target, obtaining geometric centers of its corresponding detection boxes at different moments;
obtaining a pixel point change value of the unsuccessfully matched dynamic target based on the geometric centers of the detection boxes at different moments;
comparing the obtained pixel point change values with a pixel point change threshold to obtain a dynamic target that lies within the range of the pixel point change threshold;
based on the dynamic target that lies within the pixel point change threshold, acquiring a historical scene image containing the dynamic target;
according to historical scene images and current scene images of the dynamic target that lies within the pixel point change threshold, giving a historical scene image or a current scene image of the dynamic target that has the smallest distance to the boundary of the transmission channel area;
giving a corresponding target acquisition start moment based on the historical scene image or current scene image with the smallest distance;
according to the target acquisition start moment and the acquisition moment corresponding to the current scene image, giving the interference time for the dynamic target entering the transmission channel area;
based on the interference time and the preset alarm time, giving a dynamic target for which the interference time is not less than the preset alarm time; and
generating the corresponding alarm information according to the dynamic target for which the interference time is not less than the preset alarm time.

In a second aspect, the present invention further provides a computer-vision-based safety monitoring and early warning system for a transmission line, adopting the foregoing computer-vision-based safety monitoring and early warning method for a transmission line, where the system includes:
a data acquisition module, configured to collect a scene image of the transmission line;
an image identification module, configured to identify a transmission channel area and dynamic targets on the scene image;
an interference judgment module, configured to determine an interference result between the dynamic targets and the transmission channel area based on an identification result of the transmission channel area and the dynamic targets; and
an early warning determination module, configured to determine alarm information based on the interference result.

Further, the image identification module is further configured to:
perform edge processing on the scene image to obtain edge information of straight line segments;
screen the edge information of straight line segments to give the transmission line; and
perform ground mapping on the given transmission line to form the transmission channel area.

Further, the image identification module is further configured to:
convert the scene image into a grayscale image and performing edge detection to obtain edge information;
based on a grayscale threshold, classify the edge information to obtain classified edge information;
perform binary grayscale conversion on the classified edge information to obtain a binary grayscale image;
perform Hough transform processing on the binary grayscale image to give polar coordinates of the edge information;
screen the polar coordinates of the edge information to give multiple sets of edge information that satisfy predetermined conditions; and
take the edge information of the same set as edge information of one straight line segment.

Further, the image identification module is further configured to:
classify straight line segments with the same slope in all the straight line segments into the same category;
join the ends of two straight line segments with overlapping points in each category to form a straight line segment;
based on each category of straight line segments after joining, obtain the lengths of all the straight line segments;
compare the lengths of the straight line segments in each category with a length threshold to give a straight line segment of which the length is greater than the length threshold;
take the straight line segment of which the length is greater than the length threshold in the same category as a transmission wire in the same location region; and
integrate the transmission wires in all the location regions to give the transmission line.

Further, the image identification module is further configured to:
based on a pre-built target detection model, perform target detection on the scene image to give detection boxes, target types and location information of all targets in the scene image;
obtain a target detection result of a scene image collected last time relative to the current scene image;
give current trajectory information of the dynamic target by combining the target detection results of the current scene image and the scene image collected last time; and
acquire historical trajectory information of the dynamic target and combined with the current trajectory information of the dynamic target, obtaining the trajectory information of the dynamic target.

Further, the interference judgment module is further configured to:
overlap and compare trajectory information of the dynamic targets with the transmission channel area to give an overlapping result; and
based on the overlapping result, screen out a dynamic target of which the trajectory information overlaps with the transmission channel area.

Further, the early warning determination module is further configured to:
based on the position information of all targets in the current scene image and the transmission channel area, and combined with the dynamic targets whose trajectory information overlaps with the transmission channel area, give a dynamic target located in the transmission channel area;
based on historical alarm information in a predetermined period of time, give a historical dynamic target that has been alarmed;
match the dynamic target located in the transmission channel area with the historical dynamic target that has been alarmed, to give a dynamic target that has not been successfully matched; and

generate alarm information based on the dynamic target that has not been successfully matched.

Further, the early warning determination module is further configured to:
based on the position information of all targets in the current scene image and the transmission channel area, and combined with the dynamic targets whose trajectory information overlaps with the transmission channel area, give a dynamic target located in the transmission channel area;
based on historical alarm information in a predetermined period of time, give a historical dynamic target that has been alarmed;
match the dynamic target located in the transmission channel area with the historical dynamic target that has been alarmed, to give a dynamic target that has not been successfully matched; and
generate alarm information based on the dynamic target that has not been successfully matched.

Further, the early warning determination module is further configured to:
according to the trajectory information of the unsuccessfully matched dynamic target, obtain geometric centers of its corresponding detection boxes at different moments;
obtain a pixel point change value of the unsuccessfully matched dynamic target based on the geometric centers of the detection boxes at different moments;
compare the obtained pixel point change values with a pixel point change threshold to obtain a dynamic target that lies within the range of the pixel point change threshold;
based on the dynamic target that lies within the pixel point change threshold, acquire a historical scene image containing the dynamic target;
according to historical scene images and current scene images of the dynamic target that lies within the pixel point change threshold, give a historical scene image or a current scene image of the dynamic target that has the smallest distance to the boundary of the transmission channel area;
give a corresponding target acquisition start moment based on the historical scene image or current scene image with the smallest distance;
according to the target acquisition start moment and the acquisition moment corresponding to the current scene image, give the interference time for the dynamic target entering the transmission channel area;
based on the interference time and the preset alarm time, give a dynamic target for which the interference time is not less than the preset alarm time; and
generate the corresponding alarm information according to the dynamic target for which the interference time is not less than the preset alarm time.

In a third aspect, the present invention further provides a computer-vision-based safety monitoring and early warning device for a transmission line, which includes: a transmission channel identification unit, a dynamic target identification unit, and an early warning information generation unit, where
the transmission channel identification unit is configured to collect a scene image of the transmission line;
the dynamic target identification unit is configured to identify a transmission channel area and dynamic targets on the scene image; and
the early warning information generation unit is configured to determine an interference result between the dynamic targets and the transmission channel area based on an identification result of the transmission channel area and the dynamic targets; and is further configured to determine alarm information based on the interference result.

The computer-vision-based safety monitoring and early warning method and system for a transmission line provided by the present invention has at least the following advantageous effects:

(1) The present invention can provide a transmission channel area for discriminating dangers, and can further identify the dynamic targets, thus realizing generation of alarm information for moving targets and improving the accuracy of safety early warning for the transmission line.

(2) The present invention can automatically define the transmission channel area in the vicinity of a transmission tower, greatly reducing the workload of line monitoring personnel in artificially defining transmission channels, and improving the applicability of an algorithm to a wide range of applications.

(3) By means of anti-jitter processing, trajectory analysis processing, and speed analysis processing for the moving targets, static targets and non-threatening dynamic targets can be effectively screened out, thus greatly reducing the false alarm rate, and improving the working efficiency of background monitoring personnel.

### BRIEF DESCRIPTION OF THE DRAWINGS

FIG. 1 is a flowchart of a computer-vision-based safety monitoring and early warning method for a transmission line according to the present invention;

FIG. 2 is a flowchart of obtaining line segment edge information according to an embodiment of the present invention;

FIG. 3 is a flowchart of giving a transmission line according to an embodiment of the present invention;

FIG. 4 is a flowchart of forming a transmission channel area according to an embodiment of the present invention;

FIG. 5 is a flowchart of giving trajectory information of dynamic targets according to an embodiment of the present invention;

FIG. 6 is a flowchart of generating alarm information according to an embodiment of the present invention;

FIG. 7 is a schematic diagram of a computer-vision-based safety monitoring and early warning system for a transmission line according to the present invention; and

FIG. 8 is a schematic diagram of a computer-vision-based safety monitoring and early warning device for a transmission line according to the present invention;

Meanings of numerals: 1—Transmission channel identification unit, 2—Dynamic target identification unit, 3—early warning information generation unit, 4—Edge detection subunit, 5—Edge screening subunit, 6—Line segment identification subunit, 7—Transmission wire fitting subunit, 8—Transmission wire boundary identification subunit, 9—Transmission channel generation subunit, 10—Video stack subunit, 11—Target identification model subunit, 12—Target tracking subunit, 13—Dynamic trajectory analysis unit, 14—Early warning information comparison subunit, 15—History early warning cache subunit, 16—Early warning information return subunit

### DETAILED DESCRIPTION OF THE INVENTION

In order to better understand the above technical solutions, the above technical solutions will be described in detail below with reference to the accompanying drawings and specific embodiments of the specification. Obviously, the described embodiments are only a part but not all of the embodiments of the present invention. All other embodiments obtained by persons of ordinary skill in the art based on the embodiments of the present invention without making creative efforts also fall within the scope of protection of the present invention.

The terminologies used in the embodiments of the present invention are merely used for the purpose of describing particular embodiments and are not intended to limit the present invention. The singular forms “a”, “an”, and “the” as used in the embodiments of the present invention and appended claims are intended to include the plural forms as well, and the term “multiple” generally includes at least two, unless the context clearly indicates otherwise.

It should be further noted that, the term “including”, “comprising” or any other variations thereof are intended to cover non-exclusive inclusion, so that a product or device including a series of elements not only includes the elements, but also includes other elements not explicitly listed, or inherent elements of the product or device. Without further limitations, an element defined by the statement “including a (n) . . . ” does not exclude the presence of other identical elements in the product or device including the elements.

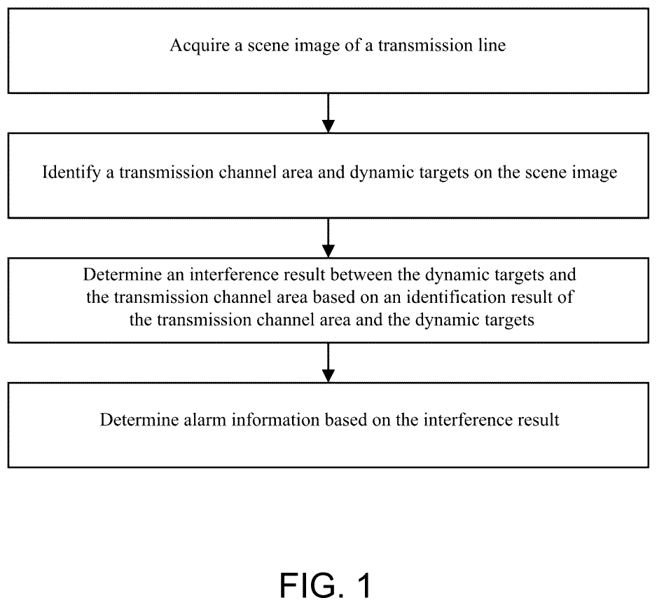

As shown in FIG. 1, the present invention provides a computer-vision-based safety monitoring and early warning method for a transmission line, which includes:
acquiring a scene image of a transmission line;
identifying a transmission channel area and dynamic targets on the scene image;
determining an interference result between the dynamic targets and the transmission channel area based on an identification result of the transmission channel area and the dynamic targets; and
determining alarm information based on the interference result.

After acquiring the scene image of the transmission line, the step of identifying the transmission channel area on the scene image may include:
performing edge processing on the scene image to obtain edge information of straight line segments;
screening the edge information of straight line segments to give the transmission line; and
performing ground mapping on the given transmission line to form the transmission channel area.

By defining the transmission channel area in the vicinity of a transmission tower, the workload of line monitoring personnel in artificially defining the transmission channel can be reduced and the applicability to a wide range of applications can be improved.

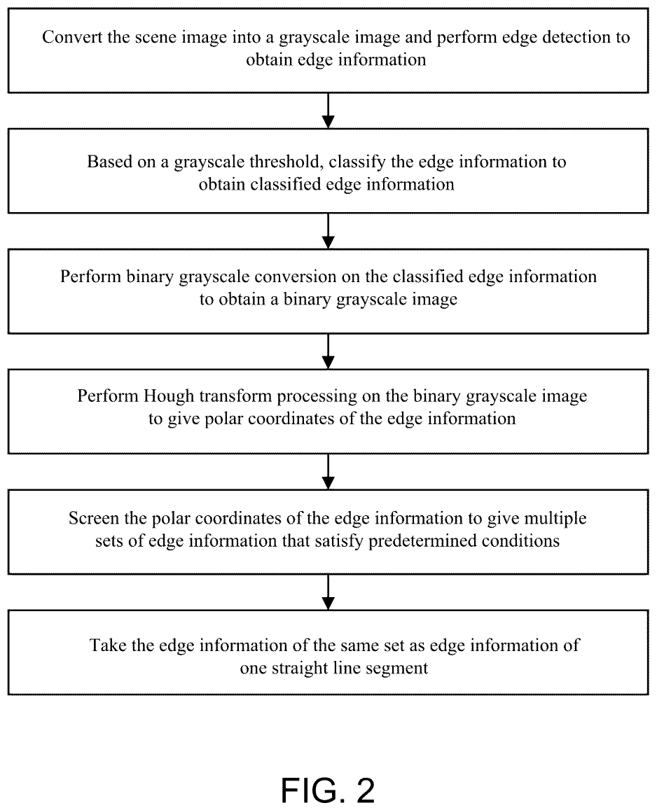

As shown in FIG. 2, in the process of identifying the transmission channel area on the scene image, the step of performing edge processing on the scene image to obtain edge information of straight line segments may include:
converting the scene image into a grayscale image and performing edge detection to obtain edge information;
based on a grayscale threshold, classifying the edge information to obtain classified edge information;
performing binary grayscale conversion on the classified edge information to obtain a binary grayscale image;
performing Hough transform processing on the binary grayscale image to give polar coordinates of the edge information;
screening the polar coordinates of the edge information to give multiple sets of edge information that satisfy predetermined conditions; and
taking the edge information of the same set as edge information of one straight line segment.

The predetermined conditions are that the number of pieces of the edge information in the same set is not less than a predetermined number, and the polar coordinates of all the edge information in the same set form a straight line segment in a polar coordinate system; and the grayscale threshold is 50. The edge information refers to edge points with corresponding coordinates in the grayscale image.

After the scene image is converted to the grayscale image, sobel operator processing can be performed on the grayscale image to complete edge detection so as to derive the edge information.

In the binary grayscale conversion of the classified edge information, the edge information that exceeds the conversion threshold is set to 1, and the edge information that is lower than the conversion threshold is set to 0.

After the Hough transform processing on the binary grayscale image, the edge points corresponding to the edge information are represented by polar coordinates in the polar coordinate system. When the screening is performed to give multiple sets of edge information that satisfy the predetermined conditions, if more than 100 pieces of edge information can be described by a polar linear equation, the edge information of the straight line segments exists in the image, and thus these pieces of edge information are retained in an edge detection result, and the rest of the edge information that does not meet this requirement will be deleted.

The step of performing Hough transform processing on the binary grayscale image to give the polar coordinates of the edge information includes:

$$y = ax + b \to r = x cos θ + y sin θ$$

In this equation, (x, y) are the coordinates of the straight line segment in the binary grayscale image in a right-angle coordinate system, a is the slope of the straight line segment, b is the intercept of the straight line segment, (r, θ) are the polar coordinates of the straight line segment in the polar coordinate system after Hough transform processing, r is the distance from the origin to the straight line segment, and θ is an angle between r and the horizontal axis in the right-angle coordinate system. Transformation to the polar coordinate aims to screen out the straight line segments that exist in the scene image, and the straight line segments that are screened out are all subsequently processed in the right-angle coordinate system.

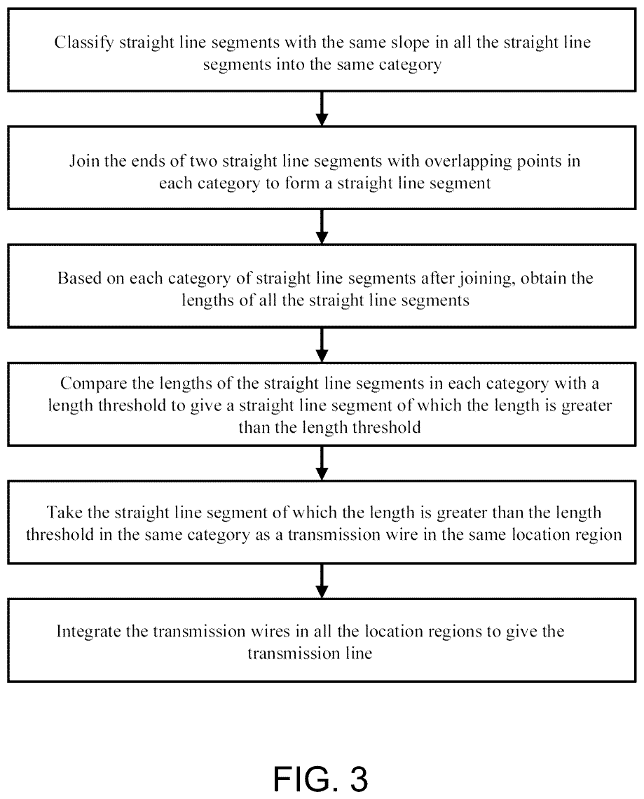

As shown in FIG. 3, after the edge information of the straight line segments is obtained, the step of screening the edge information of the straight line segments to give the transmission line may include:
classifying straight line segments with the same slope in all the straight line segments into the same category;
joining the ends of two straight line segments with overlapping points in each category to form a straight line segment;
based on each category of straight line segments after joining, obtaining the lengths of all the straight line segments;
comparing the lengths of the straight line segments in each category with a length threshold to give a straight line segment of which the length is greater than the length threshold;
taking the straight line segment of which the length is greater than the length threshold in the same category as a transmission wire in the same location region; and
integrating the transmission wires in all the location regions to give the transmission line.

The step of classifying straight line segments with the same slope in all the straight line segments into the same category includes:
making subtraction between the slopes of all the straight line segments in pairs to give slope difference results;
based on the slope difference threshold, screening all the slope difference results to give slope difference results that fall within the slope difference threshold, which is specifically as follows:

$$\vert {k}_{1} - {k}_{2} \vert < α$$

where k1 and k2 are the slopes of two straight line segments and α is the slope difference threshold, α being 0.2; and
based on the screened slope difference results, classifying two straight lines corresponding to each slope difference result into the same category.

The step of joining the ends of two straight line segments with overlapping points in each category to form a straight line segment includes:
acquiring the coordinates of the endpoints of all straight line segments in each category;
solving for an endpoint distance based on the coordinates of the endpoints of any two straight line segments in each category;
based on a distance threshold, screening all the solved endpoint distances to give endpoint distances that fall within the distance threshold, which is specifically as follows:

$$\sqrt{{( {x}_{1} - {x}_{2} )}^{2} + {( {y}_{1} - {y}_{2} )}^{2}} < β$$

where x1 and y1 are respectively the endpoint coordinates of one of the straight line segments, x2 and y2 are the endpoint coordinates of the other of the straight line segments, and β is the distance threshold, β being 20 pixels; and
classifying the two straight line segments corresponding to all given endpoint distances into two straight line segments with overlapping points and connecting the two corresponding endpoints.

In this embodiment, the polar coordinates of all sets of edge information in the same category form straight line segments with the same slope in the polar coordinate system. The length threshold is 1/20 of the Y-axis height of the binary grayscale image, that is, if the length of the straight line segment is greater than 1/20 of the Y-axis height of the binary grayscale image, the straight line segment is discriminated as a transmission wire.

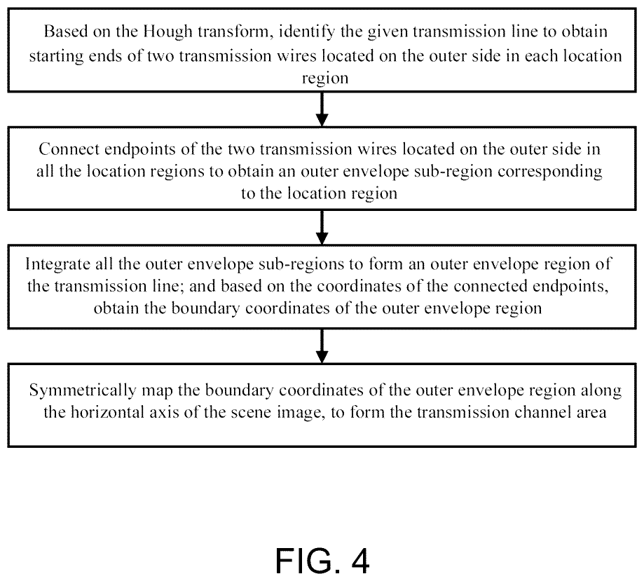

As shown in FIG. 4, after the transmission line is obtained, ground mapping may be performed on the given transmission line to form a transmission channel area, which specifically includes:
based on the Hough transform, identifying the given transmission line to obtain starting ends of two transmission wires located on the outer side in each location region;
connecting endpoints of the two transmission wires located on the outer side in all the location regions to obtain an outer envelope sub-region corresponding to the location region;
integrating all the outer envelope sub-regions to form an outer envelope region of the transmission line; and based on the coordinates of the connected endpoints, obtaining the boundary coordinates of the outer envelope region; and
symmetrically mapping the boundary coordinates of the outer envelope region along the horizontal axis of the scene image to form the transmission channel area.

Specifically, the starting ends of the transmission wires are identified in the binary grayscale image by means of the Hough transform, and a region formed by connecting all the starting ends is used as the outer envelope region of the transmission wire. In the identification based on the Hough transform, when there are two or more transmission wires in each location region, the two outermost transmission wires are automatically selected during the identification, and the starting ends of the two transmission wires are projected to the ground to obtain four boundary points which are then connected to form a quadrilateral region, to obtain the outer envelope sub-region. During ground mapping, the mapping region is: a new outer envelope region formed by symmetrically mapping the boundary coordinates of the outer envelope sub-region of the transmission line along the X-axis of the image; and this new outer envelope region is the transmission channel area. In an example of X-axis mirror-symmetric mapping, the starting coordinates are (5, 3), and are changed to (5, −3) after X-axis symmetric mapping.

In order to ensure the symmetry and length uniformity of the transmission wires on both sides in each location region, as well as the regularity of the shape of the transmission channel, after obtaining the endpoints of the two transmission wires located on the outer side in each location region, the method may further include:
acquiring the coordinates of the endpoints of the two transmission wires located on the outer side in all location regions;
for the two transmission wires located on the outer side in each location region, determining the upper and lower endpoints of each transmission wire;
performing coordinate difference processing respectively on the longitudinal coordinates of the two lower endpoints and the longitudinal coordinates of the two upper endpoints in each location region, where a coordinate difference processing result is the absolute value of the difference between the longitudinal coordinates of the two endpoints, and the endpoint difference threshold is 200 pixels;
comparing all coordinate difference processing results with the endpoint difference threshold to give coordinate difference processing results that exceed the endpoint difference threshold;
based on the given coordinate difference processing result, obtaining endpoints of two matching corresponding transmission wires; and
based on the endpoints of the two matching corresponding transmission wires, calculating the lengths of the two transmission wires corresponding to the endpoints; and for the transmission wire with a smaller length, adding a line segment having a slope same as the transmission wire and having a certain length along its matching corresponding endpoint; where the length of the added line segment is equal to a length difference between the two transmission wires.

In the present invention, after acquiring the scene image of the transmission line, dynamic targets can further be identified on the scene image while identifying the transmission channel area, which specifically includes:
based on a pre-built target detection model, performing target detection on the scene image to give detection boxes, target types and location information of all targets in the scene image;
acquiring a target detection result of a scene image collected last time relative to the current scene image;
giving current trajectory information of the dynamic target by combining the target detection results of the current scene image and the scene image collected last time; and
acquiring historical trajectory information of the dynamic target and combined with the current trajectory information of the dynamic target, obtaining the trajectory information of the dynamic target.

In the embodiment of the present invention, after each acquisition of the current scene image, the current scene image is combined with the target detection result of the scene image collected last time to give the current trajectory information of the dynamic target. That is, in the embodiment of the present invention, after the scene images are acquired at different moments, the current trajectory information of the dynamic target at its corresponding moment can be obtained. Therefore, in the embodiment of the present invention, when acquiring the historical trajectory information of the dynamic target, the information can be directly retrieved from the historical data for use. Of course, the historical trajectory information of the dynamic target in the embodiment of the present invention can also be obtained, when needed, in the process of giving the current trajectory information of the dynamic target in the embodiment of the present invention.

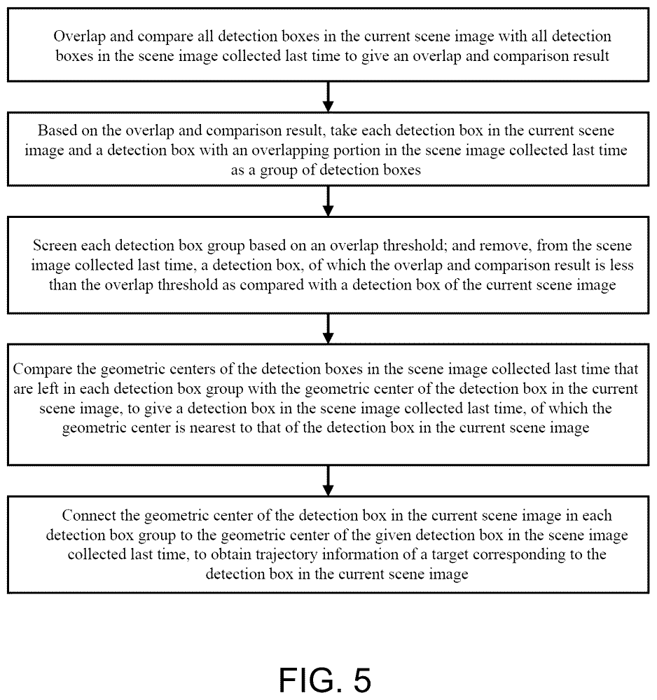

As shown in FIG. 5, the step of giving current trajectory information of the dynamic target by combining the target detection results of the current scene image and the scene image collected last time may include:
overlapping and comparing all detection boxes in the current scene image with all detection boxes in the scene image collected last time to give an overlap and comparison result;
based on the overlap and comparison result, taking each detection box in the current scene image and a detection box with an overlapping portion in the scene image collected last time as a group of detection boxes;
screening each detection box group based on an overlap threshold, and removing, from the scene image collected last time, a detection box, of which the overlap and comparison result is less than the overlap threshold as compared with the detection box of the current scene image;
comparing the geometric center of the detection boxes in the scene image collected last time that are left in each detection box group with the geometric center of the detection box in the current scene image to give a detection box in the scene image collected last time, of which the geometric center is nearest to that of the detection box in the current scene image; and
connecting the geometric center of the detection box in the current scene image in each detection box group to the geometric center of the given detection box in the scene image collected last time, to obtain trajectory information of a target corresponding to the detection box in the current scene image.

Specifically, the overlap threshold is 50%. That is, when the detection box overlap ratio (IOU) of the targets in the previous and next frames of a video (the previous and next frames respectively correspond to the scene image collected last time and the current scene image) is higher than 50%, these two targets in the previous and next frames are discriminated as the same object. Then, the current trajectory of the dynamic target can be obtained by connection of the geometric mid-points of the detection boxes of the same object in the adjacent frames.

In addition, when the detection boxes in the previous and next frames have no overlapping region, for example, when the target moves too fast or when the video has a frame drop, a target-associated algorithm based on the distance between the center points of the detection boxes will be applied to ensure continuous tracking for the target. Specifically, before the connection of the geometric center of the detection box in the current scene image in each detection box group to the geometric center of the given detection box in the scene image collected last time, the method further includes:
acquiring, from the current scene image, a detection box of which the overlap and comparison result is that there is no overlap;
calculating the distances from the geometric center of the detection box having no overlap to the geometric centers of all detection boxes in the scene image collected last time, to give a detection box in the scene image collected last time, that has the smallest distance to the detection box having no overlap; and
classifying the detection box having no overlap and the given detection box having the smallest distance into a group.

A target detection model for target detection on the scene image is pre-built. The target detection model can be pre-built through the following steps:
acquiring several historical scene images;
marking the several historical scene images with detection boxes, location information, and target types; and
training the YOLOv5s model based on the marked historical scene images, to obtain a trained YOLOv5s model.

The trained YOLOv5s model is the pre-built target detection model. The construction of the target detection model is specifically as follows: extracting features from the scene images through the backbone network; processing the extracted features by using a detection head, to obtain a predicted target detection box and target type probability; generating the size and aspect ratio of the predicted detection box by means of anchors, to obtain predicted coordinates of the detection box; and training the YOLOv5 model based on the marked scene image and the predicted target detection box, target type, and coordinates, to obtain the trained YOLOv5 model. During prediction by using the trained YOLOv5 model, the YOLOv5 model screens out a target detection box with the highest degree of confidence by means of non-maximum suppression after prediction of multiple detection boxes for the same target. The coordinates of the detection boxes are converted to position information by post-processing, and a target type with the highest prediction probability is assigned to the corresponding detection box.

Specifically, the construction of this YOLOv5s model may include:

Backbone network: YOLOv5 uses a deep neural network as the backbone to extract features from the input scene image. The backbone network is based on a convolutional neural network (CNN) architecture, such as CSPDarknet53 or MobileNetV3, which helps to capture hierarchical features from the scene image.

Detection header: The detection header is responsible for predicting a bounding box (detection box) having the detected target and the target type probability, and YOLOv5 uses a lightweight header consisting of several convolutional layers to generate a final detection output result.

Anchors: YOLOv5 predicts the bounding boxes of different sizes and aspect ratios by using anchor boxes, which are predefined boxes acting as a reference for the coordinates of a final bounding box predicted through the network.

Loss function: The loss function is used to train the YOLOv5 model by calculating the difference between the predicted bounding box and the true bounding box. The YOLOv5 model uses a combination of different loss functions, including localization loss (for the coordinates of the bounding box) and classification loss (for the target type probability).

Non-maximum suppression (NMS): After the YOLOv5 model predicts multiple bounding boxes for the same target, NMS is applied to delete duplicate detections and retain only the most confident detection result.

Post-processing: The final step involves converting the predicted bounding box coordinates into their respective positions on the scene image and assigning the correct object class to each detected bounding box based on the target type probability.

After identifying the transmission channel area and the dynamic targets on the scene image, the present invention may determine an interference result between the dynamic targets and the transmission channel area based on the identification result of the transmission channel area and the dynamic targets, which specifically includes:
overlapping and comparing trajectory information of the dynamic targets with the transmission channel area to give an overlap result; and
based on the overlap result, screening out a dynamic target of which the trajectory information overlaps and interferes with the transmission channel area.

After obtaining the interference result, the present invention may determine alarm information based on the interference result, which specifically includes:
based on the position information of all targets in the current scene image and the transmission channel area, and combined with the dynamic targets whose trajectory information overlaps with the transmission channel area, giving a dynamic target located in the transmission channel area;
based on historical alarm information in a predetermined period of time, giving a historical dynamic target that has been alarmed;
matching the dynamic target located in the transmission channel area with the historical dynamic target that has been alarmed, to give a dynamic target that has not been successfully matched; and
generating alarm information based on the dynamic target that has not been successfully matched.

The predetermined period of time is preset according to an actual transmission line monitoring scenario, and is preferably set to 30 seconds. In practical application scenarios, if the same target triggers alarms multiple times within 30 seconds, only one of the alarms is notified (i.e., there are multiple overlaps between the historical dynamic target trajectory information that has been alarmed and the transmission channel area, and only one alarm is made). If the alarm location does not change within 30 seconds, only one of the alarms is notified (i.e., the historical dynamic target that has been alarmed is always located in the transmission channel area, and only one alarm is made).

In addition, in the process of identifying dynamic targets, it is necessary to ignore the targets that move too fast or and whose trajectories briefly pass over the transmission channel, so as to avoid the misjudgment for the passing vehicles when the transmission line is close to the road. That is, the present invention can perform high-speed discrimination of the dynamic targets, where the high-speed discrimination of dynamic targets includes the following two conditions:

Excessive speed: When the target's distance from the geometric center of the detection box changes by more than 200 pixel points in adjacent frames, it is regarded that the target moves too fast and is a non-operational state.

Too short moving time in the transmission channel area: When the time interval from the dynamic target entering the transmission channel area to leaving the transmission channel area is shorter than a preset alarm time, it is regarded that the target briefly passes over the area, and no alarm is made.

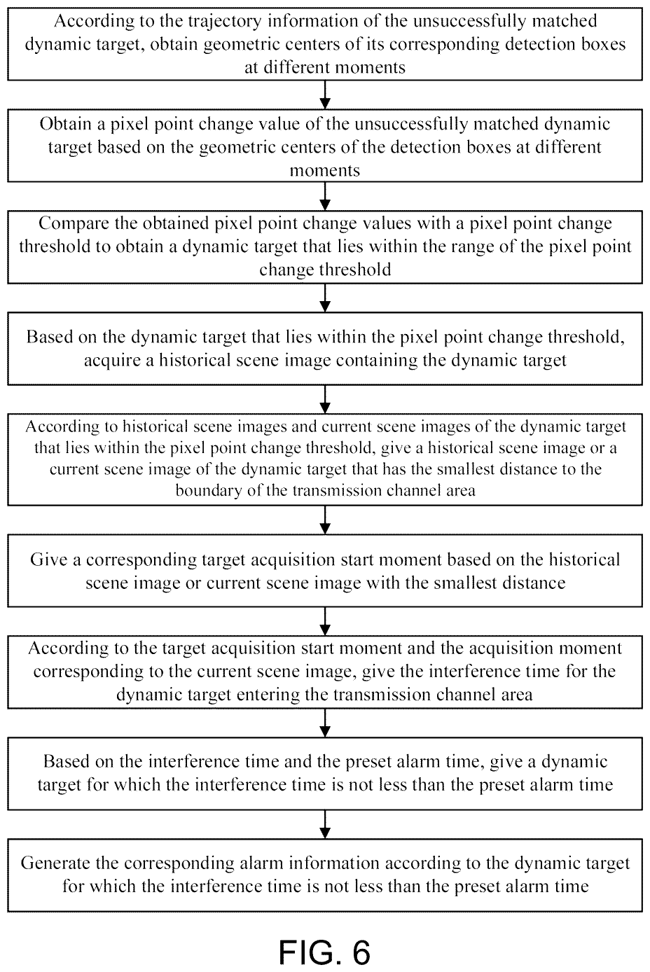

The targets in the transmission channel area can only be a threat only in a moving state. Therefore, as shown in FIG. 6, in practical application scenarios, alarm information is generated based on the dynamic target that has not been successfully matched, that is, an alarm is generated after high-speed discrimination of hazardous targets, which may specifically include:
according to the trajectory information of the unsuccessfully matched dynamic target, obtaining geometric centers of its corresponding detection boxes at different moments, where the geometric centers of the detection boxes at different moments are geometric centers of the detection boxes in the scene image at different video frames;
obtaining a pixel point change value of the unsuccessfully matched dynamic target based on the geometric centers of the detection boxes at different moments;
comparing the obtained pixel point change values with a pixel point change threshold to obtain a dynamic target that lies within the range of the pixel point change threshold, where the pixel point change threshold ranges from 10 to 200 pixel points;
based on the dynamic target that lies within the pixel point change threshold, acquiring a historical scene image containing the dynamic target;
according to historical scene images and current scene images of the dynamic target that lies within the pixel point change threshold, giving a historical scene image or a current scene image of the dynamic target that has the smallest distance to the boundary of the transmission channel area;
giving a corresponding target acquisition start moment based on the historical scene image or current scene image with the smallest distance;
according to the target acquisition start moment and the acquisition moment corresponding to the current scene image, giving the interference time for the dynamic target entering the transmission channel area;
based on the interference time and the preset alarm time, giving a dynamic target for which the interference time is not less than the preset alarm time; and
generating the corresponding alarm information according to the dynamic target for which the interference time is not less than the preset alarm time.

To sum up, the rules of generating the alarm information in the present invention are as follows: when a target continuously moves in the transmission channel area for more than a certain period of time (the preset alarm time), determining the target as a hazardous target; when a target is stationary, determining it as a non-hazardous target regardless of its location; and when the target moves outer side the transmission channel area, determining the target as a non-hazardous target as well. The alarm for the hazardous target is specifically as follows: from the time when the target enters the transmission channel area, that is, from the time when the target detection box has an overlap with the transmission channel area, if the target continuously moves and the time for which its detection box has an overlap with the transmission channel area is longer than the preset alarm time, screening out this hazardous target as a hazardous dynamic target, and generating alarm information for the target, where the early warning information includes the category of the target that triggers the alarm, the time and corresponding screenshot, and may also include the location of the target.

In addition, in the present invention, the jittering behavior of the target within a small range over a short period of time is automatically considered as a static state, so as to accommodate the phenomenon of camera jittering caused in windy weather conditions or roadbed shaking conditions. Specifically, when the target detection box continuously moves within the range of 10 pixel points during the preset alarm time, and the area of overlap between the detection boxes in the previous and next frames (the detection box of the target in the current scene image and the detection box in the scene image collected last time) continuously exceeds 95%, the target is determined as a static target, where the preset alarm time is less than a predetermined time. Specifically, the step of giving the current trajectory information of the dynamic target by combining the target detection results of the current scene image and the scene image collected last time further includes:
according to the trajectory information of all targets in the current scene image, giving an overlap and comparison result corresponding to the trajectory information of all the targets within the preset alarm time, and calculating a distance from the geometric center of the detection box in the current scene image to the geometric center of the corresponding detection box in the scene image collected last time within the preset alarm time; and
based on a dynamic overlap threshold and a dynamic distance threshold, screening the overlap and comparison results corresponding to the trajectory information of all the targets and the distances between the geometric centers, to give the trajectory information of the dynamic object, which includes:

removing the trajectory information of targets for which the overlap and comparison result is greater than the dynamic overlap threshold and the distance between the geometric centers is less than the dynamic distance threshold within the preset alarm time, and taking trajectory information of the remaining targets as the trajectory information of the dynamic targets.

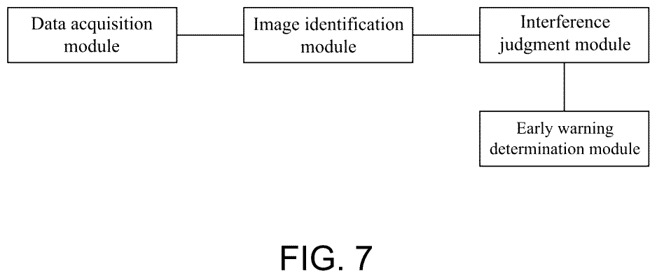

As shown in FIG. 7, the present invention further provides a computer-vision-based safety monitoring and early warning system for a transmission line, which adopts the foregoing computer-vision-based safety monitoring and early warning method for a transmission line. The system includes:
a data acquisition module, configured to collect a scene image of the transmission line;
an image identification module, configured to identify a transmission channel area and dynamic targets on the scene image;
an interference judgment module, configured to determine an interference result between the dynamic targets and the transmission channel area based on an identification result of the transmission channel area and the dynamic targets; and
an early warning determination module, configured to determine alarm information based on the interference result.

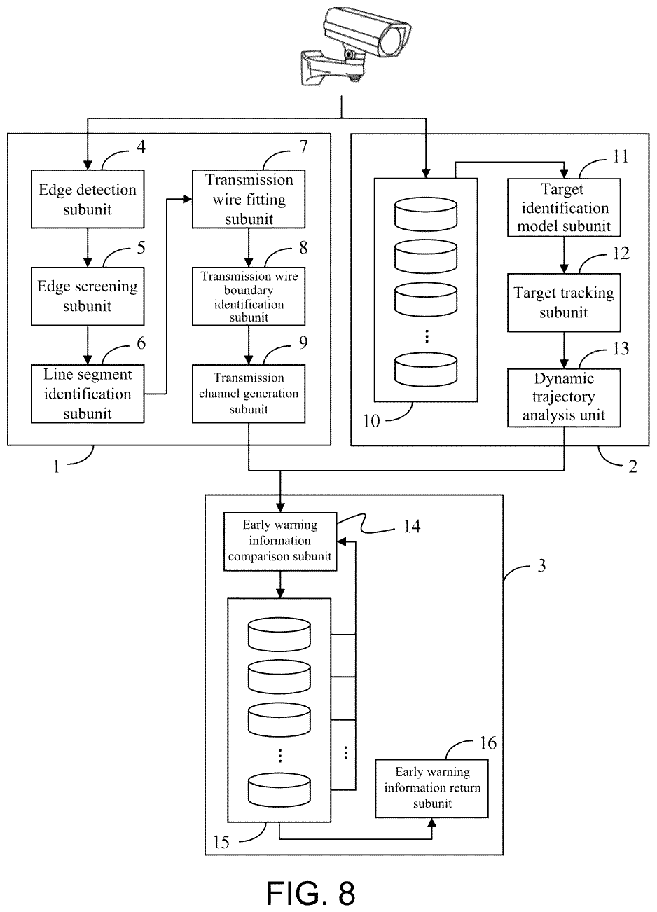

As shown in FIG. 8, the present invention further provides a computer-vision-based safety monitoring and early warning device for a transmission line, which includes a transmission channel identification unit 1, a dynamic target identification unit 2, and an early warning information generation unit 3.

The transmission channel identification unit 1 is configured to collect a scene image of the transmission line.

The dynamic target identification unit 2 is configured to identify a transmission channel area and dynamic targets on the scene image.

The early warning information generation unit 3 is configured to determine an interference result between the dynamic targets and the transmission channel area based on an identification result of the transmission channel area and the dynamic targets; and is further configured to determine alarm information based on the interference result.

The dynamic target identification unit 2 operate in series with the early warning information generation unit 3, and operates in parallel with the transmission channel identification unit 1. The transmission channel identification unit 1 and the dynamic target identification unit 2 share the same data source, where the data source may be a directly connected hardware camera device or a remote network video source. The transmission channel identification unit 1 includes an edge detection subunit 4, an edge screening subunit 5, a line segment identification subunit 6, a transmission wire fitting subunit 7, a transmission wire boundary identification subunit 8, and a transmission channel generation subunit 9, where these subunits operate in series with each other. The dynamic target identification unit 2 includes a video stack subunit 10, a target identification model subunit 11, a target tracking subunit 12, a dynamic trajectory analysis unit 13. The video stack subunit 10 operate in parallel with the target identification model subunit 11, the target tracking subunit 12 and dynamic trajectory analysis unit 13. The early warning information generation unit 3 includes an early warning information comparison subunit 14, a history early warning cache subunit 15, and an early warning information return subunit 16.

The edge detection subunit 4 converts an input scene image into a grayscale image and performs edge detection on the grayscale image by using Sobel XY operator. The edge screening subunit 5 screens a result output by the edge detection subunit 4 based on grayscale threshold filtering, and performs binary grayscale conversion for edge information after screening. The line segment identification subunit 6 performs a Hough transform operation on a binary grayscale image output by the edge screening subunit 5, to screen out edges belonging to straight line segments in the edge information. The transmission wire fitting subunit 7 fits and splices straight lines to the edge information of the straight line segments, and makes judgment based on the location, orientation, length and other information of the fitted straight line, to screen out the transmission line. The transmission wire boundary identification subunit 8 determines an outer envelope region of the transmission line on a tower having a camera according to the transmission line information output by the transmission wire fitting subunit 7. The transmission channel generation subunit 9 performs ground mapping on the outer envelope region based on transmission wire outer envelope region information output by the transmission wire boundary identification subunit 8, to form a transmission channel area. This embodiment uses a low-power transmission channel identification unit and dynamic target identification unit to conduct operation at the edge, directly performs on-site analyzation and processing on the data with limited resources, and returns only the processing result through the 4g/5g network. Thus, the traffic and bandwidth required to transmit raw data can be significantly saved, and due to the high efficiency of the low-power algorithm by the chip, a high-power power supply is not required on-site to support the device operation. The existing dynamic anomaly detection requires uninterrupted real-time anomaly identification, and image processing equipment needs to perform real-time analyzation on the streaming data, such as videos, LiDAR point cloud data, etc., collected on-site, which require that there is a real-time data processing unit on the transmission channel or field streaming data can be transmitted back to the background processing unit in real time without interruption.

The video stack subunit 10 has a fixed stack length, and when new image data (scene images) is pushed onto the stack, if the stack is full, the frontmost data in the stack is pushed out and discarded. When a data output instruction is received, the stack pushes out the last pushed-in data. The target identification model subunit 11 obtains the latest data from the video stack subunit 10, feeds the data into a target detection model to obtain a target category and location information. The target tracking subunit 12 caches the historical target category and position information output by the target identification model subunit 11, and performs target trajectory tracking for the latest target category monitoring result with reference to the historical information, to determine dynamic and static targets. The dynamic trajectory analysis unit 13, based on the dynamic target trajectory information output by the target tracking subunit 12, determines whether the activity range of the dynamic target overlaps with the transmission channel area generated by the transmission channel generation subunit 9, and finally screens out a dynamic target that is active in the transmission channel. In the present invention, by designing a soft connection between the video stack subunit 10 and the target identification model subunit, the target recognition model subunit 11 can operate on line by direct connection to the camera or operate by connection to the rear end via a network transmission channel, thus greatly improving the adaptability of the algorithm to the on-site network environment of the transmission channel.

The early warning information comparison subunit 14 determines, based on the historical early warning information in the historical early warning cache subunit 15, whether a target currently triggering the early warning has repeated alarms within a certain period of time. The historical early warning cache subunit 15 pushes the latest early warning information output by the early warning information comparison subunit 14 into the cache, for subsequent early warning information comparison. The early warning information return subunit 16 returns the latest early warning information output by the historical early warning cache subunit 15 to a cloud data platform via a 4G/LTE mobile network. The early warning information includes the category of the target that triggers the alarm, the time, and the screenshot.

The present invention processes and analyzes real-time scene images of the transmission channel acquired on-site by the monitoring camera by importing them into a computing unit with the corresponding visual processing capability, which can be deployed and installed in the on-site hardware equipment for online operation, and can also be installed in the background computing equipment to obtain real-time scene images through the network. The transmission channel identification unit, the dynamic target identification unit and early warning information generation unit proposed by the present invention can analyze and process the input video in real time. The transmission channel identification unit acquires a full-color image captured by the camera, and after black-and-white processing, performs a convolution operation on the full-color image by using the Sobel operator, to obtain edge information corresponding to the image. Then, the edge screening subunit can analyze the edge information to determine the distance, sharpness and contrast of the target edge. The edge information that is far away and has poor sharpness and poor contrast with the surroundings may be automatically filtered out. The remaining edge information is subjected to binarization and straight line segment edge screening. The screening process uses a Hough transform algorithm to filter out edges in the edge information that do not have straight line characteristics, so as to narrow down the target range of automated searching for the transmission line. Next, the transmission wire fitting subunit performs location discrimination, mutual spacing discrimination, and straight line fitting discrimination on the straight line edge information, to identify the location of transmission wires in these straight line edges. According to the positions of the transmission wires, the transmission wire boundary identification subunit gives the envelope lines of the transmission channel and performs ground projection to obtain the range of the transmission channel area. In this embodiment, by deploying surveillance cameras on a large number of towers and obtaining access permission to the cameras, the scene images are captured as training data through remote monitoring. In the existing dynamic identification process, there are not many camera resources that are disposed on-site for data acquisition, so it is difficult to obtain a desired data set for model training.

The dynamic target identification unit is responsible for locating and tracking the moving target in the real-time scene image, and comparing its motion trajectory with the transmission channel area mentioned above, and generating early warning information for this moving target if the motion trajectory of the moving target overlaps with the transmission channel. The dynamic target recognition unit is soft-connected to a video input interface during operation and runs in parallel. When the field data is interrupted for various reasons, the transmission channel identification unit will enter a hot standby mode, which can be immediately transferred to a monitoring mode when the video is restored, without the need for manual restart and intervention.

After receiving the early warning information input by the dynamic target identification unit, the early warning information generation unit, while storing the historical alarm information, compares the historical alarm information with the input early warning signal in terms of the early warning and alarm time, location, target category, and motion trajectory to determine if the alarm information is repeated. After confirming that the alarm information is correct, the early warning information generation unit generates new alarm information, which is pushed into the information cache and then sent back to the background data center through the network.

Since the transmission wire presents a natural drooping state due to gravity, the line segment identification subunit filters out straight line segments that are too long or too short by discriminating the lengths of the straight line segments after Hough transform. The transmission wire fitting subunit confirms the connection between line segments by determining the directions of different straight line segments and the distance between endpoints, and then determines whether the line segment group after connection constitutes a transmission wire. The transmission wire fitting subunit outputs an alarm signal to the lower-level unit when failing to find out sufficient transmission lines from the input image. The transmission wire boundary identification subunit automatically generates a preset transmission channel area after receiving an alarm signal indicating that the transmission wire fitting subunit has failed to find out the transmission line. The transmission wire boundary identification subunit generates alarm information sent to the background when outputting the preset transmission channel area, and background transmission line monitoring personnel can determine whether the preset transmission channel area is reasonable by visually checking the returned image. When background transmission line monitoring personnel considers that the transmission channel range is unreasonable, the area parameters can be adjusted artificially and transmitted to the operating equipment. The target tracking subunit automatically considers the jittering behavior of the target within a small range over a short period of time as a static state, so as to accommodate the phenomenon of camera jittering caused in windy weather conditions or roadbed shaking conditions. In the process of dynamic target identification, the target tracking subunit may ignore the targets that move too fast or briefly pass over the transmission channel, so as to avoid the misjudgment for the passing vehicles when the transmission line is close to the road.

The present invention also provides a method of using a visual transmission line detection device, which includes the following steps:

S1: A surveillance camera and a computing unit can be installed together on a tower, and are then connected through a USB interface, and the computing unit can also be remotely interconnected with the camera through the 4G LTE or 5G network. The specific connection method can be selected according to the network conditions of the installation site. In regions with good network conditions, remote interconnection can be selected to save installation and maintenance costs. In regions with poor network conditions, direct camera connection can be selected to save the network bandwidth.

S2: Under the condition that the equipment connection is completed, transmission line monitoring personnel feeds the camera port address or network pull address into the transmission channel identification unit so as to obtain transmission channel parameter information. For example, if the transmission channel unit sends out alarm information, it means that the preset transmission channel information is output. Then, background monitoring personnel can check whether the preset transmission channel meets the monitoring conditions when receiving the alarm information, and determines whether to change the transmission channel information by human intervention.

S3: After the transmission channel information is confirmed, transmission line monitoring personnel feeds the camera port address or network streaming address into the dynamic target identification unit and the early warning information generation unit. The dynamic moving targets in the transmission channel are marked with early warning time, category, and screenshot when meeting the dynamic target screening conditions, and are then returned to the background monitoring platform.

It can be seen that the above embodiments of the present invention achieve the following technical effects: The transmission channel identification unit realizes automatic identification of transmission channels in transmission lines, which greatly improves the adaptive ability of the algorithm to different conditions and environments, and greatly reduces the workload of line operation and maintenance personnel in artificially setting up transmission channel monitoring parameters. The dynamic target identification unit realizes the screening-out of static targets and the determination of non-hazardous dynamic targets, which greatly reduces the false alarm rate of dynamic threatening targets in various operating environments, thus reducing the disposal amount of alarm information by background operation and maintenance personnel and the disposal difficulty. The early warning information generation unit not only reduces repeated alarms by comparing with historical alarm information, but also records and marks the targets that triggers the alarms in all aspects, including the trajectory, target category, trigger time, and screenshot at the alarm triggering time, so that background operation and maintenance personnel can accurately and timely grasp the on-site conditions and the level of threat, thus making the best disposal as fast as possible.

Although preferred embodiments of the present invention have been described, those skilled in the art can also make additional changes and modifications to these embodiments once learning the basic inventive concepts. Therefore, the appended claims are intended to be construed as including the preferred embodiments as well as all changes and modifications that fall within the scope of the present invention. Obviously, those skilled in the art can make various changes and variations to the present invention without departing from the spirit and scope of the present invention. Thus, if these modifications and variations of the present invention fall within the scope of the claims of the present invention and their technical equivalents, the present invention is intended to encompass these modifications and variations as well.

What is claimed is:

1. A computer-vision-based safety monitoring and early warning method for a transmission line, comprising:
acquiring a scene image of the transmission line;
identifying a transmission channel area and dynamic targets on the scene image;
determining an interference result between the dynamic targets and the transmission channel area based on an identification result of the transmission channel area and the dynamic targets, specifically comprising: overlapping and comparing a trajectory information of the dynamic targets with the transmission channel area to give an overlap result; and based on the overlap result, screening out a dynamic target of which the trajectory information overlaps with the transmission channel area; and
determining an alarm information based on the interference result.

2. The safety monitoring and early warning method for the transmission line of claim 1, wherein the step of identifying the transmission channel area on the scene image comprises:
performing edge processing on the scene image to obtain an edge information of straight line segments;
screening the edge information of the straight line segments to give the transmission line; and
performing ground mapping on the transmission line, which is given, to form the transmission channel area.

3. The safety monitoring and early warning method for the transmission line of claim 2, wherein the step of performing edge processing on the scene image to obtain the edge information of the straight line segments comprises:
converting the scene image into a grayscale image and performing edge detection to obtain the edge information;
based on a grayscale threshold, classifying the edge information to obtain a classified edge information;
performing binary grayscale conversion on the classified edge information to obtain a binary grayscale image;
performing Hough transform processing on the binary grayscale image to give polar coordinates of the edge information;
screening the polar coordinates of the edge information to give multiple sets of edge information that satisfy predetermined conditions; and
taking the edge information of a same set as edge information of one straight line segment;
wherein the predetermined conditions are that a number of pieces of the edge information in the same set is not less than a predetermined number, and the polar coordinates of all of the edge information in the same set form a straight line segment in a polar coordinate system.

4. The safety monitoring and early warning method for the transmission line of claim 2, wherein the step of screening the edge information of the straight line segments to give the transmission line comprises:
classifying the straight line segments with a same slope in all of the straight line segments into a same category;
joining ends of two of the straight line segments with overlapping points in each of categories to form a straight line segment;
based on each of the categories of the straight line segments after joining, obtaining lengths of all of the straight line segments;
comparing lengths of the straight line segments in each of the categories with a length threshold to give a straight line segment of which a length is greater than the length threshold;
taking the straight line segment of which the length is greater than the length threshold in the same category as a transmission wire in a same location region; and
integrating the transmission wires in all of location regions to give the transmission line.

5. The safety monitoring and early warning method for the transmission line of claim 1, wherein the step of identifying the dynamic targets on the scene image comprises:
based on a pre-built target detection model, performing target detection on the scene image to give detection boxes, target types and location information of all of targets in the scene image;
obtaining a target detection result of a scene image collected last time relative to a current scene image;
giving a current trajectory information of the dynamic target by combining target detection results of the current scene image and the scene image collected last time; and
acquiring a historical trajectory information of the dynamic target and combined with the current trajectory information of the dynamic target, obtaining the trajectory information of the dynamic target.

6. The safety monitoring and early warning method for the transmission line of claim 5, wherein the step of giving current trajectory information of the dynamic target by combining the target detection results of the current scene image and the scene image collected last time comprises:
overlapping and comparing all detection boxes in the current scene image with all detection boxes in the scene image collected last time to give an overlap and comparison result;
based on the overlap and comparison result, taking each of detection boxes in the current scene image and a detection box with an overlapping portion in the scene image collected last time as a group of the detection boxes;
screening each of the detection boxes group based on an overlap threshold, and removing, from the scene image collected last time, the detection box, of which the overlap and comparison result is less than the overlap threshold as compared with the detection box of the current scene image;
comparing geometric centers of the detection boxes in the scene image collected last time that are left in each of the detection boxes group with the geometric centers of the detection box in the current scene image to give a detection box in the scene image collected last time, of which geometric center is nearest to that of the detection box in the current scene image; and
connecting the geometric center of the detection box in the current scene image in each of detection boxes group to the geometric center of the detection box, which is given, in the scene image collected last time, to obtain trajectory information of a target corresponding to the detection box in the current scene image.

7. The safety monitoring and early warning method for the transmission line of claim 6, wherein the step of giving the current trajectory information of the dynamic target by combining the target detection results of the current scene image and the scene image collected last time further comprises:
according to the trajectory information of all of the targets in the current scene image, giving the overlap and comparison results corresponding to the trajectory information of all of the targets within a preset alarm time, and calculating a distance from the geometric center of the detection box in the current scene image to the geometric center of a corresponding detection box in the scene image collected last time within a preset alarm time; and
based on a dynamic overlap threshold and a dynamic distance threshold, screening the overlap and comparison results corresponding to the trajectory information of all of the targets and distances between the geometric centers, to give the trajectory information of dynamic object, which includes:
removing the trajectory information of targets for which the overlap and comparison result is greater than the dynamic overlap threshold and a distance between the geometric centers is less than the dynamic distance threshold within the preset alarm time, and taking the trajectory information of remaining targets as the trajectory information of the dynamic targets.

8. The safety monitoring and early warning method for the transmission line of claim 5, wherein the step of determining the alarm information based on the interference result comprises:
based on position information of all of the targets in the current scene image and the transmission channel area, and combined with the dynamic targets whose the trajectory information overlaps with the transmission channel area, giving a dynamic target located in the transmission channel area;
based on a historical alarm information in a predetermined period of time, giving a historical dynamic target that has been alarmed;
matching the dynamic target located in the transmission channel area with the historical dynamic target that has been alarmed, to give a dynamic target that has not been successfully matched; and
generating the alarm information based on the dynamic target that has not been successfully matched.

9. The safety monitoring and early warning method for the transmission line of claim 8, wherein the step of generating the alarm information based on the dynamic target that has not been successfully matched comprises:
according to a trajectory information of a dynamic target, which is unsuccessfully matched, obtaining geometric centers of its corresponding detection boxes at different moments;
obtaining a pixel point change value of the dynamic target, which is unsuccessfully matched, based on the geometric centers of the detection boxes at different moments;
comparing an obtained pixel point change value with a pixel point change threshold to obtain a dynamic target that lies within a range of the pixel point change threshold;
based on the dynamic target that lies within the pixel point change threshold, acquiring a historical scene image containing the dynamic target;
according to the historical scene images and current scene images of the dynamic target that lies within the pixel point change threshold, giving a historical scene image or a current scene image of a dynamic target that has a smallest distance to boundary of the transmission channel area;
giving a corresponding target acquisition start moment based on the historical scene image or the current scene image with the smallest distance;
according to a target acquisition start moment and an acquisition moment corresponding to the current scene image, giving an interference time for the dynamic target entering the transmission channel area;
based on the interference time and the preset alarm time, giving a dynamic target for which the interference time is not less than the preset alarm time; and
generating a corresponding alarm information according to the dynamic target for which the interference time is not less than the preset alarm time.

10. A computer-vision-based safety monitoring and early warning system for the transmission line, adopting the computer-vision-based safety monitoring and early warning method for the transmission line according to claim 1, the system comprising:
a data acquisition module, configured to collect a scene image of the transmission line;
an image identification module, configured to identify the transmission channel area and the dynamic targets on the scene image;
an interference judgment module, configured to determine the interference result between the dynamic targets and the transmission channel area based on the identification result of the transmission channel area and the dynamic targets; and
an early warning determination module, configured to determine the alarm information based on the interference result.

11. The safety monitoring and early warning method for the transmission line of claim 3, wherein the step of screening the edge information of the straight line segments to give the transmission line comprises:
classifying the straight line segments with a same slope in all of the straight line segments into a same category;
joining ends of two of the straight line segments with overlapping points in each of categories to form a straight line segment;
based on each of the categories of the straight line segments after joining, obtaining lengths of all of the straight line segments;
comparing lengths of the straight line segments in each of the categories with a length threshold to give a straight line segment of which a length is greater than the length threshold;
taking the straight line segment of which the length is greater than the length threshold in the same category as a transmission wire in a same location region; and
integrating the transmission wires in all of location regions to give the transmission line.

12. The safety monitoring and early warning method for the transmission line of any one of claim 7, wherein the step of determining the alarm information based on the interference result comprises:
based on position information of all of the targets in the current scene image and the transmission channel area, and combined with the dynamic targets whose the trajectory information overlaps with the transmission channel area, giving a dynamic target located in the transmission channel area;
based on a historical alarm information in a predetermined period of time, giving a historical dynamic target that has been alarmed;
matching the dynamic target located in the transmission channel area with the historical dynamic target that has been alarmed, to give a dynamic target that has not been successfully matched; and
generating the alarm information based on the dynamic target that has not been successfully matched.

13. A computer-vision-based safety monitoring and early warning system for the transmission line, adopting the computer-vision-based safety monitoring and early warning method for the transmission line according to claim 2, the system comprising:
a data acquisition module, configured to collect a scene image of the transmission line;
an image identification module, configured to identify the transmission channel area and the dynamic targets on the scene image;
an interference judgment module, configured to determine the interference result between the dynamic targets and the transmission channel area based on the identification result of the transmission channel area and the dynamic targets; and
an early warning determination module, configured to determine the alarm information based on the interference result.

14. A computer-vision-based safety monitoring and early warning system for the transmission line, adopting the computer-vision-based safety monitoring and early warning method for the transmission line according to claim 3, the system comprising:
a data acquisition module, configured to collect a scene image of the transmission line;
an image identification module, configured to identify the transmission channel area and the dynamic targets on the scene image;
an interference judgment module, configured to determine the interference result between the dynamic targets and the transmission channel area based on the identification result of the transmission channel area and the dynamic targets; and
an early warning determination module, configured to determine the alarm information based on the interference result.

15. A computer-vision-based safety monitoring and early warning system for the transmission line, adopting the computer-vision-based safety monitoring and early warning method for the transmission line according to claim 4, the system comprising:
a data acquisition module, configured to collect a scene image of the transmission line;
an image identification module, configured to identify the transmission channel area and the dynamic targets on the scene image;
an interference judgment module, configured to determine the interference result between the dynamic targets and the transmission channel area based on the identification result of the transmission channel area and the dynamic targets; and
an early warning determination module, configured to determine the alarm information based on the interference result.

16. A computer-vision-based safety monitoring and early warning system for the transmission line, adopting the computer-vision-based safety monitoring and early warning method for the transmission line according to claim 5, the system comprising:
a data acquisition module, configured to collect a scene image of the transmission line;
an image identification module, configured to identify the transmission channel area and the dynamic targets on the scene image;
an interference judgment module, configured to determine the interference result between the dynamic targets and the transmission channel area based on the identification result of the transmission channel area and the dynamic targets; and
an early warning determination module, configured to determine the alarm information based on the interference result.

17. A computer-vision-based safety monitoring and early warning system for the transmission line, adopting the computer-vision-based safety monitoring and early warning method for the transmission line according to claim 6, the system comprising:
a data acquisition module, configured to collect a scene image of the transmission line;
an image identification module, configured to identify the transmission channel area and the dynamic targets on the scene image;
an interference judgment module, configured to determine the interference result between the dynamic targets and the transmission channel area based on the identification result of the transmission channel area and the dynamic targets; and
an early warning determination module, configured to determine the alarm information based on the interference result.

18. A computer-vision-based safety monitoring and early warning system for the transmission line, adopting the computer-vision-based safety monitoring and early warning method for the transmission line according to claim 7, the system comprising:
a data acquisition module, configured to collect a scene image of the transmission line;
an image identification module, configured to identify the transmission channel area and the dynamic targets on the scene image;
an interference judgment module, configured to determine the interference result between the dynamic targets and the transmission channel area based on the identification result of the transmission channel area and the dynamic targets; and
an early warning determination module, configured to determine the alarm information based on the interference result.

19. A computer-vision-based safety monitoring and early warning system for the transmission line, adopting the computer-vision-based safety monitoring and early warning method for the transmission line according to claim 8, the system comprising:
a data acquisition module, configured to collect a scene image of the transmission line;
an image identification module, configured to identify the transmission channel area and the dynamic targets on the scene image;
an interference judgment module, configured to determine the interference result between the dynamic targets and the transmission channel area based on the identification result of the transmission channel area and the dynamic targets; and
an early warning determination module, configured to determine the alarm information based on the interference result.

20. A computer-vision-based safety monitoring and early warning system for the transmission line, adopting the computer-vision-based safety monitoring and early warning method for the transmission line according to claim 9, the system comprising:
a data acquisition module, configured to collect a scene image of the transmission line;
an image identification module, configured to identify the transmission channel area and the dynamic targets on the scene image;
an interference judgment module, configured to determine the interference result between the dynamic targets and the transmission channel area based on the identification result of the transmission channel area and the dynamic targets; and
an early warning determination module, configured to determine the alarm information based on the interference result.
